(19) United States
(12) Patent Application Publication
(10) Pub. No.: US 2026/0286084 A1
(43) Pub. Date: Sep. 24, 2026

(54) Aqueous Silk Fibroin From Silk Textiles

(71) Applicant: CANON VIRGINIA, INC., Newport News, VA (US)

(72) Inventors: Yoko Fukuda, Yorktown, VA (US); Andre Smagin, Carrollton, VA (US)

(21) Appl. No.: 19/563,856

(22) Filed: Mar. 11, 2026

Related U.S. Application Data
(60) Provisional application No. 63/770,248, filed on Mar. 11, 2025.

(51) Int. Cl. C08J 11/08; D06P 5/13

(52) U.S. Cl. CPC C08J 11/08; D06P 5/131; D06P 5/134; D06P 5/137; C08J 2389/00

(57) ABSTRACT

There is provided methods of preparing aqueous silk fibroin from recycled silk textiles. The methods can include removing dye from recycled silk textiles prior to preparing the aqueous silk fibroin. The method can include pre-treating the recycled silk with a dye removal agent, optionally in the presence of heat, dissolving the textile, dialyzing the dissolved textile, and optionally centrifuging the dialyzed solution. There is also provided a two-step process that utilizes heat and pressure incubation of the textile with dye removal solution prior to dissolving the textile. As a result of the provided methods, an aqueous silk fibroin product is produced that can be colorless or have a desired level of coloration for downstream usage.

### CROSS-REFERENCE TO RELATED APPLICATION

The present application claims the benefit of priority of U.S. Provisional Patent Application No. 63/770,248 filed Mar. 11, 2025, the contents of which is hereby incorporated herein by reference.

### FIELD OF THE DISCLOSURE

The present application relates to the preparation of aqueous silk fibroin from recycled silk sources instead of directly from raw silk cocoons.

### BACKGROUND

Silk fibers and textiles are considered one of the most highly-valued and luxurious materials due to its costly production, sheen, softness, and other high-quality characteristics. However, large volumes of waste textiles are constantly generated from the textile industry, including from the silk textile industry, that end up discarded in landfills. For this reason, attempts to find alternate uses for waste and/or discarded textiles to reduce environmental impacts are growing.

In addition to the traditional use of silk in textiles, new uses for silk and its components have been found. Fibroin, one of the two main proteins found in silk, has been found to be useful in numerous technical fields, ranging from agriculture, biomedical applications, biomaterials, cosmetics, and numerous others. Typically, fibroin is obtained initially in solution, notably as aqueous silk fibroin (ASF). ASF is obtained from raw silk cocoons, such as from Bombyx mori silkworms. The silk cocoons are boiled, rinsed to remove sericin, the other main protein, and the silk is then dissolved in aqueous solution. See, for example, U.S. Pat. No. 7,635,755, the contents of which are incorporated herein in its entirety.

Based on the environmental waste in the textile industry and the growing desire to reduce such waste, there is growing interest in finding alternative uses for textile waste. Where a component of a textile shares a common starting material with another product, a means of substituting a waste product for the initial starting would be highly valuable from a sustainability and circular economy perspective.

### SUMMARY OF THE DISCLOSURE

The present disclosure therefore relates to the preparation of ASF from existing silk textiles instead of from raw silk cocoons.

Thus, in one aspect, the present disclosure provides processes for preparing aqueous silk fibroin from a textile, comprising the steps of dissolving the textile, and performing dialysis or diafiltration on a solution comprising the fibroin from the dissolved textile. In some embodiments, the textile can be incubated with a dye removal solution prior to dissolving to alter the coloration of the final ASF product.

In another aspect, there is provided processes for preparing aqueous silk fibroin from a textile wherein the dye removal step and the dissolution step are performed simultaneously using a dye removal solution that also functions as a dissolution solution.

In a further aspect, there is provided processes for preparing aqueous silk fibroin from a textile wherein the textile is subjected to at least one period of incubation under high heat and pressure to remove the dye from the textile and/or to dissolve the textile, while in the presence of a dye removal solution and/or a dissolving solution.

Additionally, there is provided an aqueous silk fibroin that is prepared by any of the processes described herein.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

The patent or application file contains at least one drawing executed in color. Copies of this patent or patent application publication with color drawing(s) will be provided by the Office upon request and payment of the necessary fee.

FIG. 1 is a flow chart of a process for preparing aqueous silk fibroin from a silk textile according to the present disclosure.

FIG. 2 is a flow chart of a process for preparing aqueous silk fibroin from a silk textile where dye is removed from the textile according to the present disclosure.

FIG. 3 is a flow chart of a process for preparing aqueous silk fibroin from a silk textile where the silk textile undergoes a pre-wash according to the present disclosure.

FIG. 4 is a flow chart of a process for preparing aqueous silk fibroin from a silk textile using two pressure cooking steps according to the present disclosure.

FIG. 5A-D are photographs of experimental results according to the present disclosure.

FIG. 6A-D are photographs of experimental results according to the present disclosure.

FIG. 7A-E are photographs of experimental results according to the present disclosure.

FIG. 8A-D are photographs of experimental results according to the present disclosure.

FIG. 9A-C are photographs of experimental results according to the present disclosure.

FIG. 10A-H are photographs of experimental results according to the present disclosure.

FIG. 11A-C are photographs of experimental results according to the present disclosure.

FIG. 12 is a UV-VIS spectra graph depicting absorbance of light over various wavelengths for ASF produced as experimental results according to the present disclosure.

FIG. 13 is a UV-VIS spectra graph depicting absorbance of light over various wavelengths for ASF produced as experimental results according to the present disclosure. disclosure.

FIG. 15 is a UV-VIS spectra graph depicting absorbance of light over various wavelengths for ASF produced as experimental results according to the present disclosure.

FIG. 16 is a UV-VIS spectra graph depicting absorbance of light over various wavelengths for ASF produced as experimental results according to the present disclosure.

FIG. 17A-C are photographs of experimental results according to the present disclosure.

FIG. 18 is a UV-VIS spectra graph depicting absorbance of light over various wavelengths for ASF produced as experimental results according to the present disclosure.

FIG. 19 is a UV-VIS spectra graph depicting absorbance of light over various wavelengths for ASF produced as experimental results according to the present disclosure.

FIG. 20A-D are photographs of experimental results according to the present disclosure.

FIG. 14A-C are photographs of experimental results according to the present disclosure.

FIG. 21A-V are photographs of experimental results according to the present disclosure.

FIG. 22 is a UV-VIS spectra graph depicting absorbance of light over various wavelengths for dye removal solutions following removal of dye from a textile, as used in obtaining experimental results according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENT

The present disclosure has several embodiments and relies on patents, patent applications and other references for details known to those of skill in the art. Therefore, when a patent, patent application, or other reference is cited or repeated herein, it should be understood that it is incorporated by reference in its entirety for all purposes as well as for the proposition that is recited.

The embodiments described herein are processes to make ASF from silk textiles with varying amounts of dye remaining in the resulting ASF. The standard method to make ASF from Bombyx mori cocoons comprises degumming, dissolving, dialysis or diafiltration, and centrifuging.

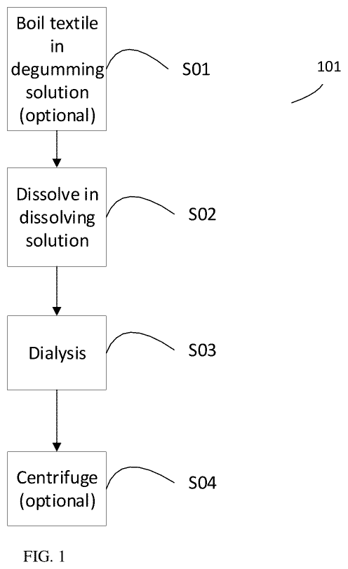

The present disclosure provides Process 101 to make ASF from silk textiles as shown in FIG. 1, including from recycled silk textiles. In Step S01, the textile is boiled in a degumming solution before dissolving to allow for easier dissolution.

The degumming solution can comprise a sodium carbonate (Na₂CO₃) solution, sodium dodecyl sulfate (SDS), an enzyme solution such as papain, surfactants such as sodium oleate, soaps such as olive oil soap and Marseille soap, alkaline solutions such as sodium hydroxide, calcium hydroxide and sodium bicarbonate, and acidic solutions such as citric acid and tartaric acid. For example, a solution of sodium carbonate can range in concentration from about 0.01M to about 1M, from about 0.02M to about 0.07M, from about 0.03M to about 0.06M, or from about 0.04M to about 0.05M. Degumming can occur over a time period of from about 10 minutes to 60 minutes, or about 15 minutes to 45 minutes, or about 30 minutes.

Following boiling, in Step S02 the textile is incubated with a dissolution solution. For instance a textile can be added into a vessel containing a calculated volume of a dissolution solution based on the weight of the textile, for instance a beaker, which can then be covered to prevent evaporation, and incubated at a temperature of, for example 60°−80° C.

Dissolution solutions can be aqueous salt solutions in one embodiment. Salts useful for dissolution in an aqueous solution can include, but are not limited to, lithium bromide (LiBr), lithium thiocyanate, calcium nitrate or other chemicals capable of solubilizing silk. Salt solutions, for instance, can have concentrations of from 9.0-10.0M. Alternative agents (in addition to the aqueous salt solutions described above) to dissolve the textile can be other ionic solutions including lithium/sodium thiocyanate, nitrate containing compounds, Hexafluoroisopropanol (HFIP), cupriethylenediamine (CED), phosphoric acid, lithium chloride (LiCl), ionic liquids, 1-allyl-3-methylimidazolium chloride ([AMIM]Cl) or ajisawa reagents, i.e, a solution of CaCl₂, ethanol and water.

Time for dissolution can range from about 10 minutes to about 210 minutes or more, including from about 15 minutes to about 200 minutes, from about 30 minutes to about 190 minutes, from about 45 minutes to about 150 minutes, from about 60 minutes to about 120 minutes, or from about 75 minutes to about 90 minutes. In general, a lower concentration solution may need a longer dissolving time, whereas a higher concentration solution may accomplish dissolution in a shorter time period.

However, a shorter dissolving time, lower incubation temperature, and lower volumes of dissolution solutions, including but not limited to aqueous salt solutions, are possible if boiling of the textile is performed before the dissolution.

Once the textile has dissolved and been cooled to room temperature, in Step S03, the dissolved solution was inserted into a dialysis cassette for dialysis. Alternatively, diafiltration can be used in place of dialysis. Dialysis and diafiltration can be performed according to standard protocols understood in the chemical arts. After dialysis is completed, in Step S04, the ASF can optionally be centrifuged to remove impurities. While optional, centrifugation can remove any undissolved material or impurities in the ASF. In this method described in FIG. 1, the dye from the original silk textile remains in the ASF produced.

The present disclosure provides further methods to prepare ASF that include an additional optional step of removing the dye from the original silk textiles. Color removers that can be used in this step include non-reductive (oxidative) bleaches such as chlorine-based, (sodium hypochlorite, calcium hypochlorite), oxygen-based (hydrogen peroxide, sodium percarbonate, sodium perborate, ozone), Peracetic Acid, and Potassium Persulfate; Reductive bleaches such as Bisulfites/Sulfites (sulfur dioxide, sodium bisulfite, sodium metabisulfite, sodium dithionite, thiourea dioxide, formamidine sulfinic acid), water, boiling water, acids (Vinegar, oxalic acid, Hydrochloric acid, Formic acid) and surfactants/emulsifiers (Sodium oleate, Soap (Marseille soap), Sodium dodecyl sulfate (SDS)). In practice, any chemical known to remove dye can be used.

Throughout this disclosure, temperatures used are as described herein, with heating or warming a solution or textile including temperatures from 50-100° C., 60-100° C., 70-100° C., 80-100° C.2, or 90-100° C., boiling refers to a temperature of at least 100° C., and pressure cooking refers to temperatures of 100° C. or more, 110° C. or more, 120° C. or more, or 130° C. or more.

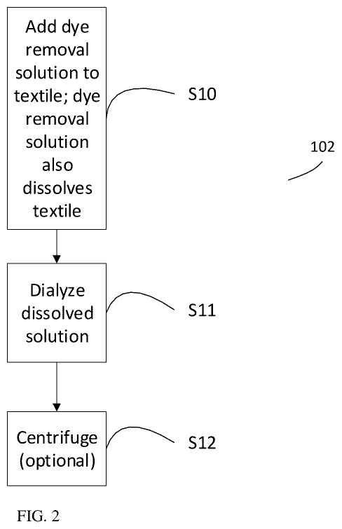

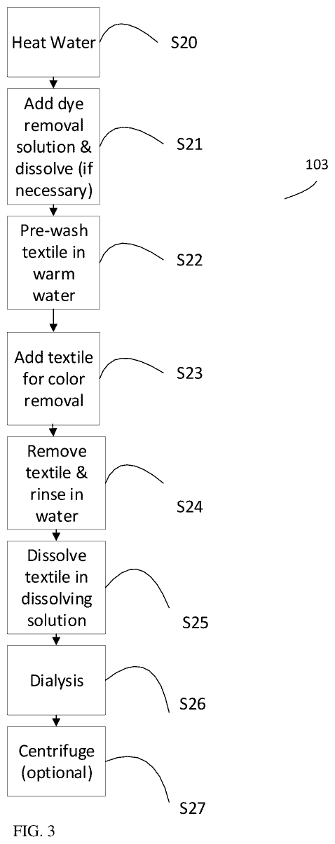

With reference to FIG. 2, a further Process 102 of preparing ASF from a textile is provided which contains an additional step S10 of adding a dye removal solution to the textile. Dye removal solutions can be any of those described herein. In some embodiments, the dye removal solution can be a sodium hypochlorite (NaOCl) solution, such as those found in commercial bleach. Use of a dye removal solution such as this provides an efficiency gain as textile dissolution and dye removal can occur in one step. Thus, in such an example, during Step S10, a textile can be placed in a reaction vessel, for example, a beaker with a stir bar, and a dye removal solution such as NaOCl solution diluted with water to 2-3% active chlorine is added. The dye removal solution both removes the color from the textile and dissolves it. Once the textile dissolves completely, in Step S11, the resulting solution is inserted into a dialysis cassette for dialysis to remove the dye removal solution. Alternatively, diafiltration can be used in place of dialysis, with the result of either process then continuing to Step S12. Once dialysis or diafiltration is complete, in Step S12, the ASF can optionally be centrifuged to remove impurities. ASF produced by Process 102 will be colorless and similar in appearance to ASF made from Bombyx mori silkworm cocoons. The advantage of the process of FIG. 2 is that the dissolution and dye removal can be performed in one step by using a dye removal solution such as NaOCl. While this is due to the effect of chlorine reducing the integrity of the textile, disintegration of the textile and the silk fibroin can occur when using higher concentrations or extended incubation periods (beyond those described herein).

Process 103 described in FIG. 3, can be used with dye removal solutions that will not also cause dissolving of the textile. For instance, a dye remover such as the commercially available RIT color remover, a non-chlorine reductive bleach, will not damage or weaken the silk fiber while removing the dye from the textile. RIT comprises sodium hydrosulfite (Na₂S₂O₄, also known as sodium dithionite), sodium carbonate, tetra sodium salt of ethylene diamine tetraacetic acid and sodium metasilicate anhydrous, with sodium hydrosulfite and sodium carbonate as the active ingredients. RIT color remover is a dyeing aid to remove the existing color from yet-to-be dyed fabric and is also a solution for removing food stains or dye stains. In Process 103, Steps S20 and S21 are used to prepare the dye removal solution from a solid form. In the instance of use of a dye removal solution such as RIT, the directions on the commercial product can be followed as shown in Steps S20 and S21 of FIG. 3.

In Step S22, the textile is pre-washed in warm water. In S20, a vessel, such as a beaker with a stir bar, is filled with water, covered, and heated to just below boiling (90-95° C.). After the water begins to simmer, in Step S21, the color remover is added. In Step S23, the textile is added to the water once the color remover has dissolved completely. In Step S24, the textile is removed from the beaker once it turns white/off-white. The textile is rinsed in warm water first followed by cool water until the water turns clear. If necessary or desired, the process of Steps S20-S24, can be repeated for additional color removal. Once the dye removal process is complete, the textile is dried. Drying of the textile can include any method such as air drying at room temperature (RT) or in the presence of a heat source. In Step S25, a dissolving solution is added to the textile and placed in the oven for dissolution. Dissolving solutions can be any of those previously described, including, but not limited to LiBr solution or alternative agents such as ajisawa reagents, i.e, a solution of CaCl₂), ethanol and water. In Step S26, the dissolved solution is inserted into a dialysis cassette for dialysis. Alternatively, diafiltration can be used in place of dialysis with the result then continuing to Step S27. Dialysis or diafiltration are performed according to known procedures in the chemical arts to remove the dissolution solution. After dialysis is complete, in Step S27, the ASF can optionally be centrifuged to remove impurities. Process 103 as provided in FIG. 3 produces ASF significantly lighter in color compared to ASF that is made without any dye removal process, including as in Process 101 of FIG. 1. Further, the use of a dye removal solution such as RIT color remover or other similar solutions allows for this dye removal without physical damage to the silk fiber.

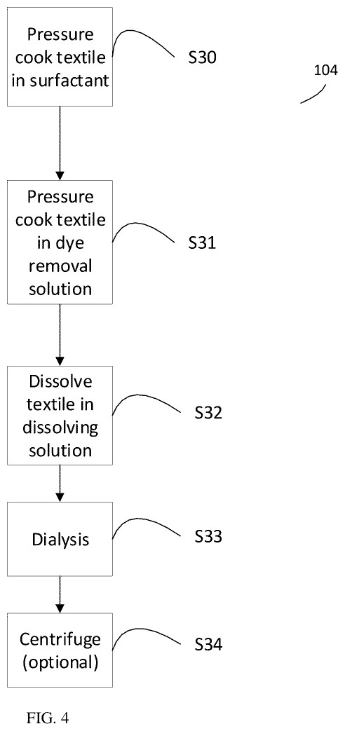

Process 104 provided in FIG. 4 uses a 2-step, high temperature process to effectively remove the dye from the textile, allowing for production of clear or substantially clear ASF. In Step S30, as a pre-treatment to remove some of the dye, the textile is soaked in a degumming solution, such as sodium oleate solution, at a temperature of at least 100° C., or at least 110° C., or at least 120° C. in a pressurized vessel for about 30 minutes to about 2 hours, or about 1 hour. After the textile is rinsed in water, in Step S31, it is soaked again in the pressurized vessel at a temperature of at least 100° C., or at least 110° C., or at least 120° C., for about 30 minutes to about 2 hours, or about 1 hour, in a dye removal solution. By way of non-limiting example, dye removal solutions such as the RIT color remover or Na₂CO₃/sodium hydrosulfite (Na₂S₂O₄) solution can be used, although these can also be substituted by any of the dye removal solutions described herein. Once the dye removal process is complete, in Step S32, a dissolving solution was used to dissolve the textile. As described herein, salt solutions, or any of the other solutions provided above, including alternative agents such as ajisawa reagents, i.e, a solution of CaCl₂), ethanol and water can be used. In Step S33, the dissolved solution is inserted into a dialysis cassette for dialysis. Alternatively, diafiltration can be used in place of dialysis with the result then continuing to Step S34. Dialysis and or/diafiltration are performed according to standard procedure in the chemical arts. After dialysis, in Step S34, the ASF can optionally be centrifuged to remove impurities. Use of this 2-step high temperature process can be effective in producing colorless ASF without physical damage to the silk fiber.

Processes 101, 102, 103 and 104, as described in FIGS. 1-4, can be used interchangeably, depending on the desired ASF to be obtained, and the various solutions that are to be used. Choice of solutions used can be made based on availability, cost, environmental impacts, and other factors. The degumming, dissolution and dye removal solutions described herein above can be used in any of Processes 101, 102, 103 and 104, as described in FIGS. 1-4, unless they have been described as having characteristics that would be unsuitable. For instance, in Process 102, shown in FIG. 2, the dye removal solution must also be capable of dissolving the textile, such that a dye removal solution such as RIT color remover would not be used in Process 102.

Further, while the disclosure has referred to silk fibroin obtained from silk fabric, such fabric can be made from silk from Bombyx mori silkworms, insect silk, or spider silk, or other species that produce silk material.

Thus, based on the process descriptions discussed herein, in one embodiment there is provided a process for preparing aqueous silk fibroin from a textile comprising silk, comprising the steps of: optionally boiling the textile; dissolving the textile; and performing dialysis or diafiltration on a solution resulting from dissolving the textile. The process of optionally boiling the textile can occur in the presence of a degumming solution. Degumming solutions can include any of sodium carbonate (Na₂CO₃) solution, sodium dodecyl sulfate (SDS), an enzyme solution, papain, a surfactant, sodium oleate, soap, olive oil soap, Marseille soap, alkaline solution, sodium hydroxide, calcium hydroxide, sodium bicarbonate, acidic solutions, citric acid and tartaric acid, or any combination thereof. In some instances, the degumming solution can be Na₂CO₃. Na₂CO₃ can be present in an amount from about 0.01M to about 1M, or from about 0.02M to about 0.09M, from about 0.03M to about 0.08M, from about 0.04M to about. 07M, or from about 0.05M to about 0.06M.

The textiles are dissolved in the presence of a dissolving solution. The dissolving solutions can include any of aqueous salt solutions, lithium bromide (LiBr), lithium thiocyanate, calcium nitrate solution, calcium chloride-formic acid, lithium/sodium thiocyanate, solutions of nitrate containing compounds, Hexafluoroisopropanol (HFIP), cupriethylenediamine (CED), phosphoric acid, lithium chloride (LiCl), ionic liquids, 1-allyl-3-methylimidazolium chloride ([AMIM]Cl), ajisawa reagents and CaCl₂:ethanol:water, along with any other compound that solubilizes silk, or combinations thereof. In some instances, the dissolving solution can be an aqueous solution of LiBr. The LiBr can be present in an amount from about 9M to about 10M, from about 9.1M to about 9.9M, from about 9.2M to about 9.8M, from about 9.3M to about 9.7M, from about 9.4M to about 9.6M, or about 9.5M.

The processes described herein can additionally comprise the step of removing dye from the textile. Removing dye from the textile can comprise incubating the textile or the aqueous silk fibroin in a dye removal solution. Dye removal solutions can include a solution including any of non-reductive (oxidative) bleaches, chlorine-based bleach, sodium hypochlorite (NaOCl), calcium hypochlorite, oxygen-based bleach, hydrogen peroxide, sodium percarbonate, sodium perborate, ozone, Peracetic Acid, Potassium Persulfate, reductive bleaches, Bisulfites/Sulfites, sulfur dioxide, sodium bisulfite, sodium metabisulfite, sodium dithionite, thiourea dioxide, formamidine sulfinic acid, RIT color remover, sodium hydrosulfite, sodium carbonate, water, acids, vinegar, oxalic acid, hydrochloric acid, formic acid, surfactants, emulsifiers, sodium oleate, soap, Marseille soap, sodium dodecyl sulfate (SDS), and any combinations thereof. In some instances, the dye removal solution can comprise NaOCl or Na₂CO₃/Na₂S₂O₄. NaOCl can be present in an amount from about 0.1% to about 4%, from about. 3% to about 3.8%, from about 0.4% to about 3.7%, from about 0.5% to about 3.6%, from about. 6% to about 3.5%, from about 0.7% to about 3.4%, from about 0.8% to about 3.3%, from about 0.9% to about 3.2%, from about 1.0% to about 3.1%, from about 1.1% to about 3.0%, from about 1.2% to about 2.9%, from about 1.3% to about 2.8%, from about 1.4% to about 2.7%, from about 1.5% to about 2.6%, from about 1.6% to about 2.5%, from about 1.7% to about 2.4%, from about 1.8% to about 2.3%, from about 1.9% to about 2.2%, from about 2.0% to about 2.1%, and from about 2.1% to about 2.0%. Na₂CO₃ can be present in an amount from about 0.1% to about 4%, from about 0.3% to about 3.8%, from about 0.4% to about 3.7%, from about 0.5% to about 3.6%, from about 0.6% to about 3.5%, from about 0.7% to about 3.4%, from about 0.8% to about 3.3%, from about 0.9% to about 3.2%, from about 1.0% to about 3.1%, from about 1.1% to about 3.0%, from about 1.2% to about 2.9%, from about 1.3% to about 2.8%, from about 1.4% to about 2.7%, from about 1.5% to about 2.6%, from about 1.6% to about 2.5%, from about 1.7% to about 2.4%, from about 1.8% to about 2.3%, from about 1.9% to about 2.2%, from about 2.0% to about 2.1%, and from about 2.1% to about 2.0%. Further, Na₂S₂O₄ can be present in an amount from about 0.1% to about 4%, from about 0.3% to about 3.8%, from about 0.4% to about 3.7%, from about. 5% to about 3.6%, from about 0.6% to about 3.5%, from about 0.7% to about 3.4%, from about. 8% to about 3.3%, from about 0.9% to about 3.2%, from about 1.0% to about 3.1%, from about 1.1% to about 3.0%, from about 1.2% to about 2.9%, from about 1.3% to about 2.8%, from about 1.4% to about 2.7%, from about 1.5% to about 2.6%, from about 1.6% to about 2.5%, from about 1.7% to about 2.4%, from about 1.8% to about 2.3%, from about 1.9% to about 2.2%, from about 2.0% to about 2.1%, and from about 2.1% to about 2.0%.

In some embodiments, the step of removing dye from the textile comprises incubating the textile in a solution comprising sodium hydrosulfite and sodium carbonate prior to dissolving the textile. In some instances, the step of removing dye from the textile and dissolving the textile can occur simultaneously. For example, NaOCl can function as both a dye removal solution and a dissolving solution, such that the NaOCl additionally dissolves the textile.

In some instances, the processes described herein can include incubating the textile in a heated and pressurized vessel in the presence of a surfactant as described herein, and incubating the textile in a heated and pressurized vessel in the presence of a dye removal solution, as described herein. Such incubation can be referred to as “pressure cooking”.

In some embodiments, there is provided a process for preparing aqueous silk fibroin from a textile, comprising the steps of: adding the textile to a dissolving solution, wherein the solution dissolves the textile; performing dialysis or diafiltration on the dissolved textile solution; and, optionally centrifuging the dialyzed or diafiltration solution. In other embodiments, a process for preparing aqueous silk fibroin from a textile, can comprise the steps of: pre-washing the textile in warm water; adding a dye removal agent to hot water; pre-washing the textile in warm water; adding the textile into the dye removal solution; removing the textile; rinsing the textile in water; dissolving the textile; performing dialysis or diafiltration on the dissolved textile solution; and, optionally centrifuging the dialyzed or diafiltration solution.

The present disclosure additionally provides embodiments wherein a process for preparing aqueous silk fibroin from a textile, comprises the steps of: pressure-cooking the textile in a first dye removal solution; pressure-cooking the textile in a second dye removal solution; dissolving the textile; performing dialysis or diafiltration on the dissolved textile solution; and, optionally centrifuging the dialyzed or diafiltration solution. The first dye removal solution can comprise a surfactant. In certain instances, this process can include a dye removal solution that comprises sodium oleate and a dye removal solution that comprises Na₂CO₃/Na₂S₂O₄.

Additional embodiments include an aqueous silk fibroin prepared by dissolving a textile comprising silk. Such aqueous silk fibroin can be prepared from a silk textile using any of the processes described herein, including using any of the described solutions in any of the described amounts or concentrations.

In one embodiment, an aqueous silk fibroin prepared by dissolving a textile comprising silk, can include the steps of: providing a silk textile; optionally boiling the textile; dissolving the textile; and performing dialysis or diafiltration on a solution resulting from dissolving the textile; wherein the dialyzed solution comprises aqueous silk fibroin. The aqueous silk fibroin can be prepared such that the textile is treated to remove dye prior to concurrent with dissolving the textile, providing a clear or substantially clear aqueous silk fibroin.

It is within the scope of the present disclosure that any of the processes herein can be customized as to the solutions used, the amounts of active ingredients in the solutions, the incubation times, and incubation temperatures, such that an aqueous silk fibroin can be prepared having a desired coloration or lack thereof, depending on desired downstream uses.

The disclosure will be further characterized by the following examples which are intended to be exemplary of the disclosure.

### EXAMPLES

### Example 1—No Dye Removal

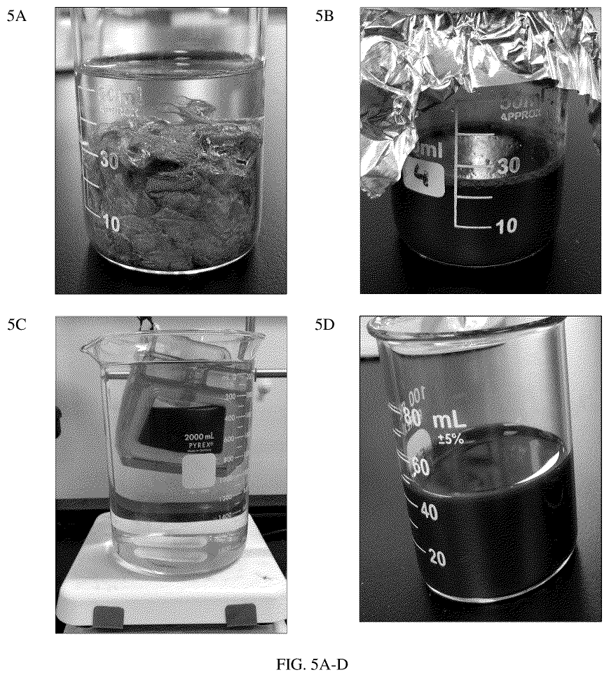

An experiment was run using the standard process for production of ASF from recycled silk textile material as described herein. A silk textile was boiled in 0.02M sodium carbonate (Na₂CO₃) solution for 30 minutes to degum the textile. The boiled textile was then placed in a beaker with a calculated volume of 9.3M LiBr solution based on the weight of the textile. The textile in solution was covered with aluminum foil to prevent evaporation, and incubated in an oven set at 60° C. to allow the textile to dissolve. After dissolving, the dissolved textile in solution was allowed to cool to room temperature and was inserted into a dialysis cassette or dialysis. Following dialysis, the resulting ASF was centrifuged to remove impurities. FIG. 5A-D provides photographs of the process. FIG. 5A shows the silk textile before dissolving, FIG. 5B shows the dissolved textile, FIG. 5C shows dialysis of the resulting solution, and FIG. 5D shows the final ASF following centrifugation.

### Example 2—NaOCl for Dye Removal and Dissolving

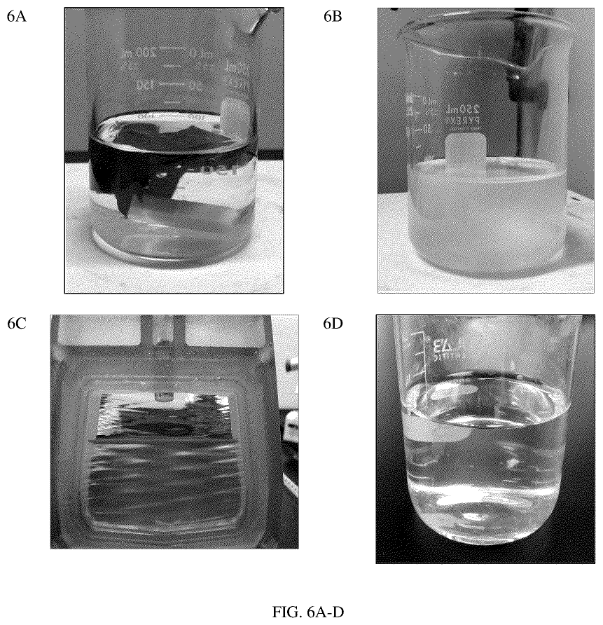

An experiment was run using a process for removing dye during the preparation of ASF from silk textiles using the process shown in FIG. 2. The silk textile was placed in a beaker with a stir bar and NaOCl solution diluted with water to 2-3% active chlorine was added. Once the textile dissolved completely, the solution was inserted into a dialysis cassette for dialysis. Following dialysis, the ASF was centrifuged to remove impurities. The resulting ASF was colorless and similar in appearance to ASF made from Bombyx mori silkworm cocoons. Incubation with the NaOCl served the dual purpose of degumming and dissolving the textile while removing the original dye. FIG. 6A-D provides photographs of the process: FIG. 6A shows the silk textile during degumming, FIG. 6B shows the dissolved textile, FIG. 6C shows dialysis of the resulting solution, and FIG. 6D shows the final ASF following centrifugation. As shown in FIG. 6D, the resulting ASF is visually substantially clear.

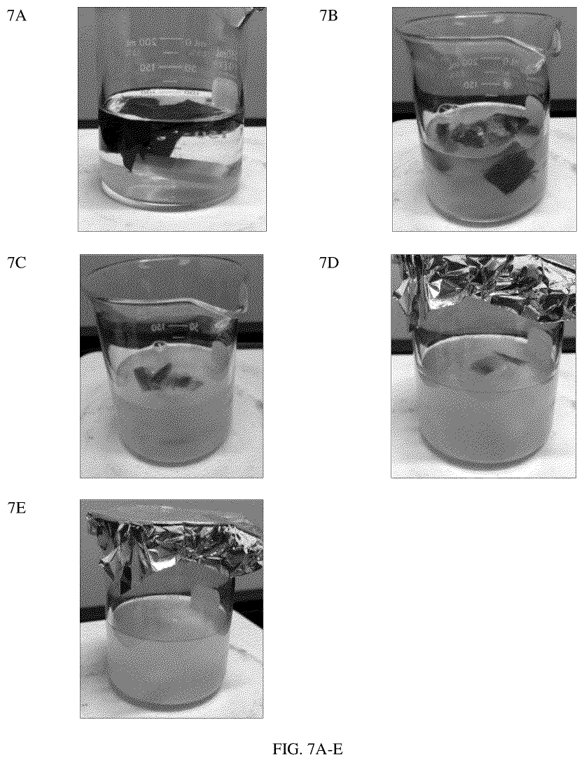

A further experiment was run to determine the amount of physical damage to the textile that was caused by the NaOCl solution. FIG. 7A-E provides photographs showing the visible physical damage to the textile at immediately after addition of NaOCl (FIG. 7A), and at 5 minutes (FIG. 7B), 6 minutes (FIG. 7C), 17 minutes (FIG. 7D), and 2 hours post addition (FIG. 7E).

### Example 3—Commercial Color Remover

An experiment was run using the process for removing dye during the preparation of ASF from silk textiles using commercial dye removal chemistry in the form of RIT Color Remover. Water was heated in a covered beaker containing a stir bar until just below boiling (90-95° C.). When the water began simmering, the RIT was added to the water and dissolved according to package directions. The silk textile underwent a pre-wash in warm water and was added to the beaker once the RIT had fully dissolved. The textile remained in the simmering beaker until it had turned white or off-white (>120 min.). The textile was rinsed first in warm water then in cool water until the water ran clear. Once thoroughly rinsed, the textile was allowed to dry.

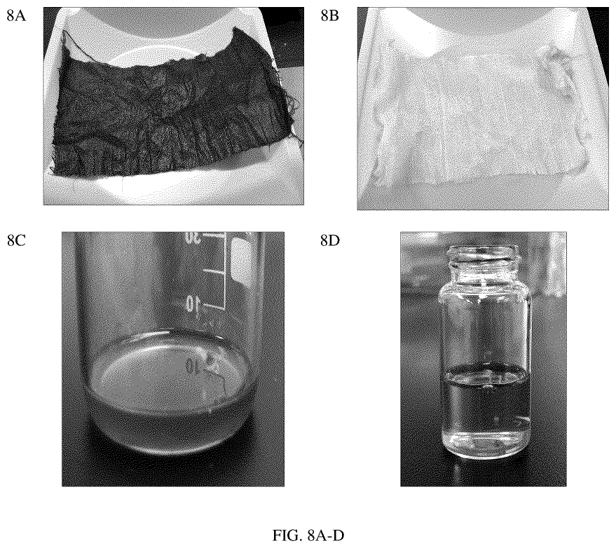

The textile was then dissolved in 9.3M LiBr solution while incubating in an oven. Following complete dissolving of the textile, the solution was inserted into a dialysis cassette and dialysis was performed. Following dialysis, centrifugation was performed to remove impurities. FIG. 8A-D provides photographs of the process. These include: the silk textile prior to dye removal (FIG. 8A), the textile following dye removal (FIG. 8B), the results of dialysis of the solution (FIG. 8C), and the final ASF following centrifuging (FIG. 8D). The resulting ASF has a visible red/pink tinge.

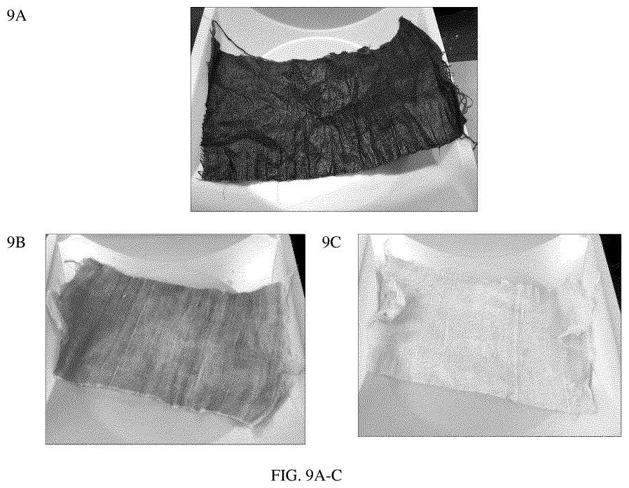

A further experiment was run to determine the amount of physical damage to the textile that was caused by the RIT color remover solution. FIG. 9A-C provides photographs showing the lack of visible physical damage to the textile when processed at 90-95° C., at the following time points: after pre-wash in warm water (FIG. 9A), after the first 60 minute dye removal cycles (FIG. 9B), and after a second 60 minute dye removal cycle (120 minutes total) (FIG. 9C).

### Example 4—Dye Removal Comparison

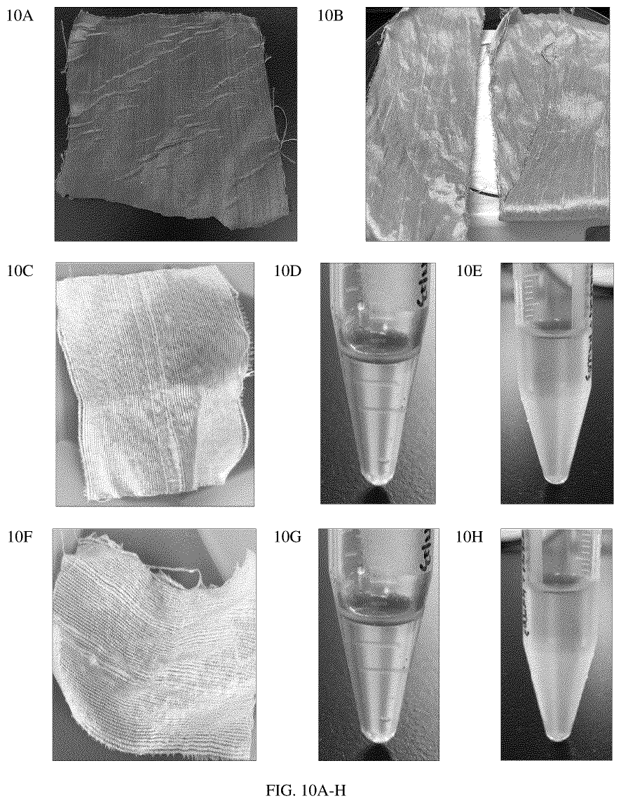

An experiment was run using the process for removing dye during the preparation of ASF from silk textiles according to Examples 2 and 3 as provided above. A textile was split into two pieces and the same ASF production/dye removal procedure was performed on each piece, varying in the dye removal solution used. The silk textile pieces were first subjected to a pressurized pre-treatment with sodium oleate solution wherein it was soaked in the sodium oleate solution at 120° C. in a pressurized vessel for 1 hour. FIG. 10A-B provides photographs showing the original whole textile and the split textile pieces following the pressurized pre-treatment. The textile pieces were rinsed in water, and were soaked again at 120° C. in the pressurized vessel in one of two dye removal solution: the RIT color remover or Na₂CO₃/sodium hydrosulfite (Na₂S₂O₄) solution. Following completion of the dye removal process (textiles were white or off-white), the textiles were dissolved in 9.3M LiBr solution. The dissolved solutions were inserted into dialysis cassettes and dialysis was performed. Following dialysis, each resulting ASF was centrifuged to remove impurities. FIG. 10C-H provides photographs of the textile pieces following a second pressurized treatment with either RIT Color Remover (FIG. 10C) or Na₂CO₃/sodium hydrosulfite (Na₂S₂O₄) solution (FIG. 10F), followed directly by the photos showing the solution following dissolving the textile (FIG. 10D—RIT and FIG. 10G—Na₂CO₃/sodium hydrosulfite (Na₂S₂O₄) solution) and the ASF after centrifugation FIG. 10E—RIT and FIG. 10H—Na₂CO₃/sodium hydrosulfite (Na₂S₂O₄) solution).

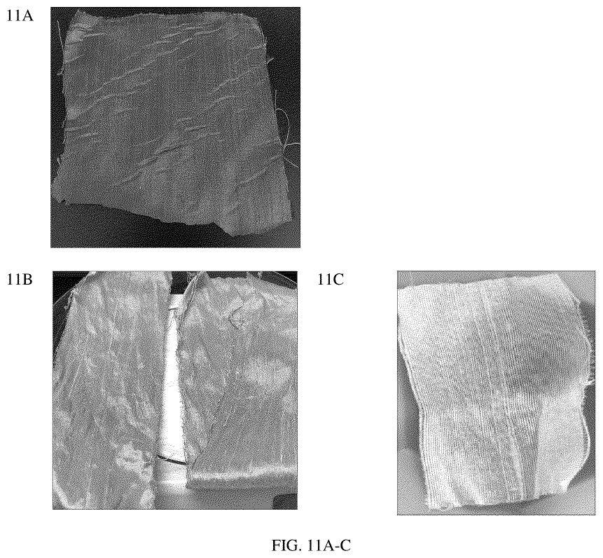

No visual physical damage of the silk textile was detected as shown in FIG. 11A-C. FIG. 11A shows the initial textile, FIG. 11B shows the textile after being soaked in the pressurized vessels containing the dye removal solutions at 120° C. for 1 hour, and FIG. 11C shows the textile after a further 60 minutes in the pressurized vessels at 120° C. (120 minutes total).

### Example 5—Quantitative Analysis (Percent Color Reduction)

Each of the ASF samples produced in Examples 1-4 was analyzed with the NanoDrop 2000 Spectrophotometer to determine the amount of color remaining in the samples. The table below shows the maximum absorbance value of each ASF sample from the wavelength range of 450-600 nm. The wavelength range was chosen to be specific for this red fabric color which absorbs green and blue wavelengths and reflects red wavelengths. The percentage of color reduction was calculated using the textile ASF from Example 1 (the textile was directly dissolved in 9.3M LiBr without any color removal treatment) as the reference value:

$$( \% reduction = \frac{initial fabric absorbance - sample absorbance}{inital sample absorbance} ) . \qquad Equation 1$$

A further control was provided using ASF obtained from raw Bombyx mori cocoons using the same dissolution process. The results are shown in Table 1.

TABLE 1

| Sample | Maximum Absorbance | % Color |
|---|---|---|
| Description | (450-600 nm) | Reduction |
| Bombyx mori | 0.014 | 99.4 |
| cocoon ASF | | |
| Textile ASF | 2.530 | Reference |
| (Example 1) | | |
| 30 min “degummed” ASF | 2.094 | 17.2 |
| Example 2 ASF | 0.002 | 99.9 |
| Example 3 ASF | 0.033 | 98.7 |
| Example 4 ASF | 0.022 | 99.1 |
| (RIT Color Remover) | | |
| Example 4 ASF | 0.017 | 99.3 |
| (Na₂CO₃/Na₂S₂O₄) | | |

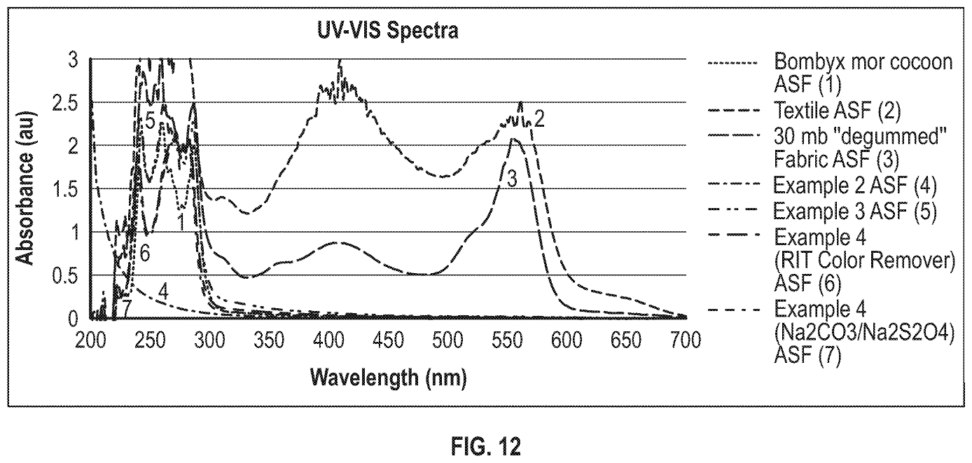

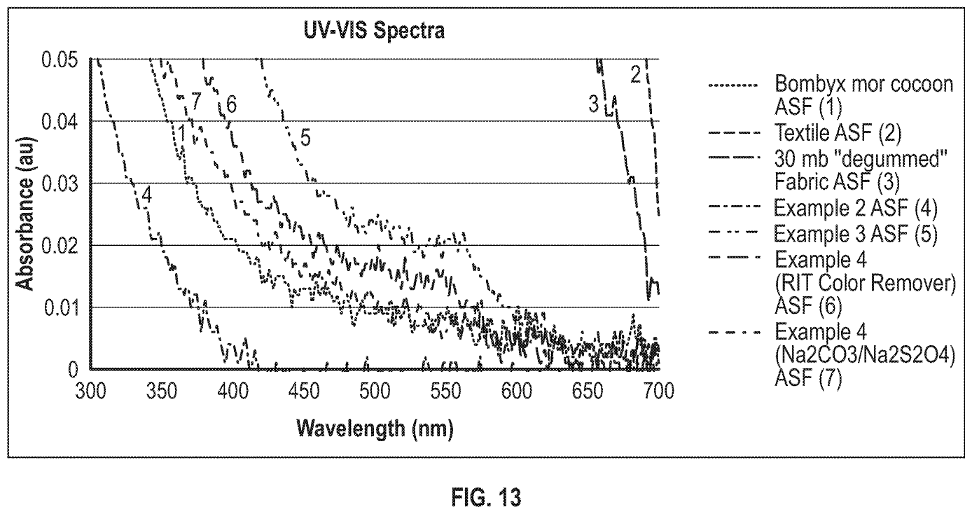

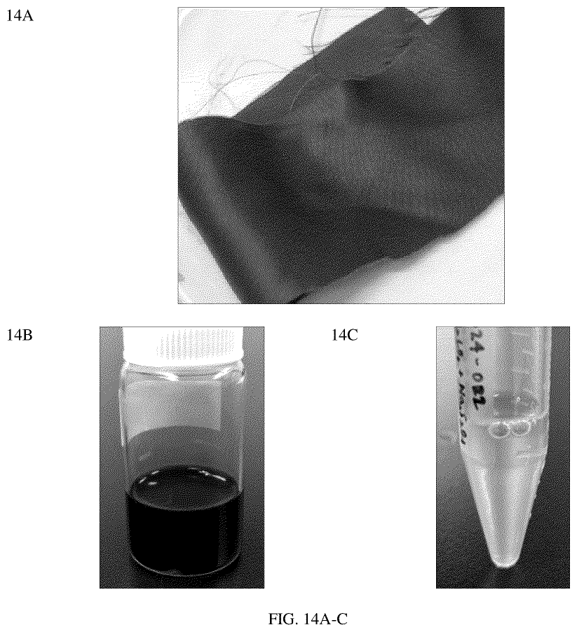

Graphs showing the UV-VIS spectra of the samples described in Table 1 are shown in FIGS. 12 and 13. The spectrum in FIG. 13 is a magnification of the first spectrum at 450-600 nm.

A further experiment was run using the procedure of Example 4 with starting materials of a blue silk textile and a printed silk textile. For the dye removal solution, a 2-step high temperature process of sodium oleate treatment followed by Na₂CO₃/Na₂S₂O₄ was used as previously described in Example 4. As a control, ASF was additionally obtained from a piece of the blue silk textile that had no dye removal treatment. A further control was provided using ASF obtained from raw Bombyx mori cocoons using the same dissolution process.

### Example 6—Dye Removal from Blue and Patterned Textiles

FIG. 14A-C provides images of the original blue silk fabric (FIG. 14A), the dissolved textile (FIG. 14B), and the final ASF with the dye removal treatment of Embodiment 3 (FIG. 14C). FIG. 17A-C provides images of the original printed silk fabric (FIG. 17A), the dissolved textile (FIG. 17B), and the final ASF with the dye removal treatment of Embodiment 3 (FIG. 17C).

The ASF samples were analyzed with the NanoDrop 2000 Spectrophotometer to determine the amount of color remaining in the samples. The table below shows the maximum absorbance value of each ASF sample from the wavelength range of 500-700 nm. The percentage of color reduction was calculated as described in Example 5. The resulting percent color reduction is shown in Table 2 for the blue textile, and Table 3 for the patterned textile.

TABLE 2

| Sample | Maximum Absorbance | % Color |
|---|---|---|
| Description | (500-700 nm) | Reduction |
| Bombyx mori | 0.011 | 99.7 |
| cocoon ASF | | |
| Textile ASF | 3.281 | Reference |
| (no dye removal) | | |
| Dye-Removed ASF | 0.011 | 99.7 |

TABLE 3

| Sample | Maximum Absorbance | % Color |
|---|---|---|
| Description | (500-700 nm) | Reduction |
| Bombyx mori | 0.011 | 99.7 |
| cocoon ASF | | |
| Textile ASF | 3.281 | Reference |
| (no dye removal) | | |
| Dye-RemovedASF | 0.011 | 99.7 |

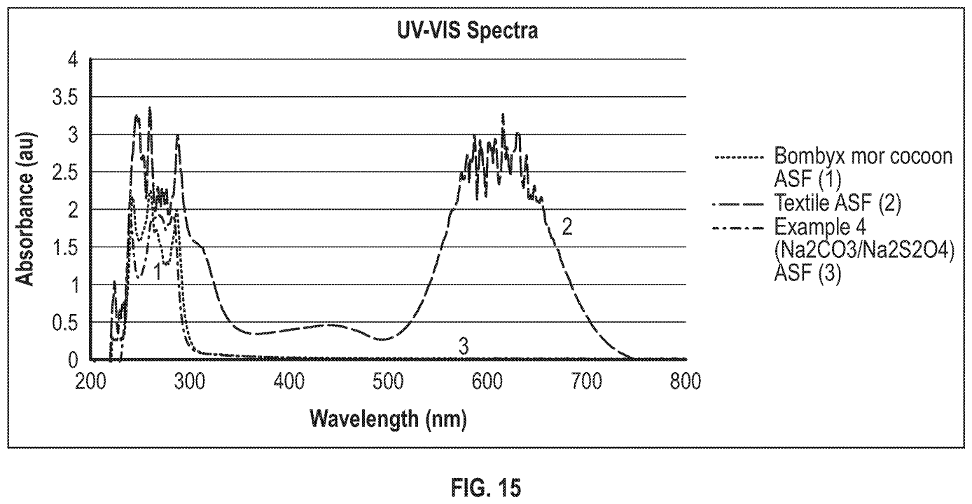

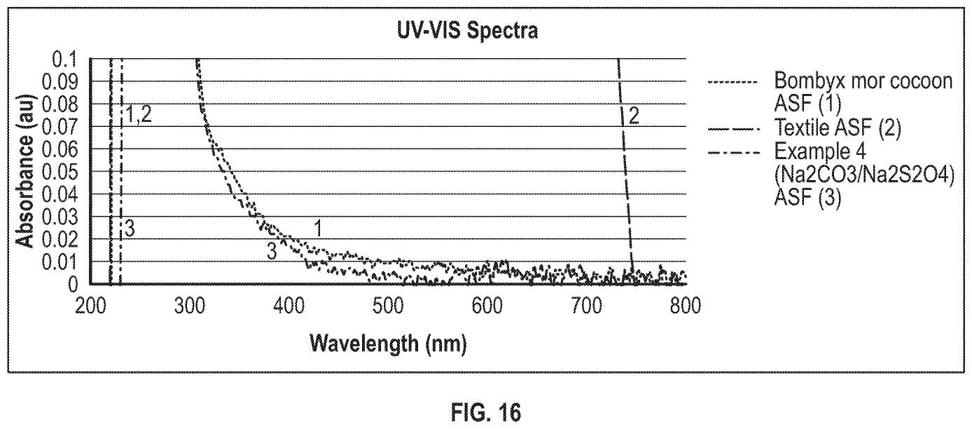

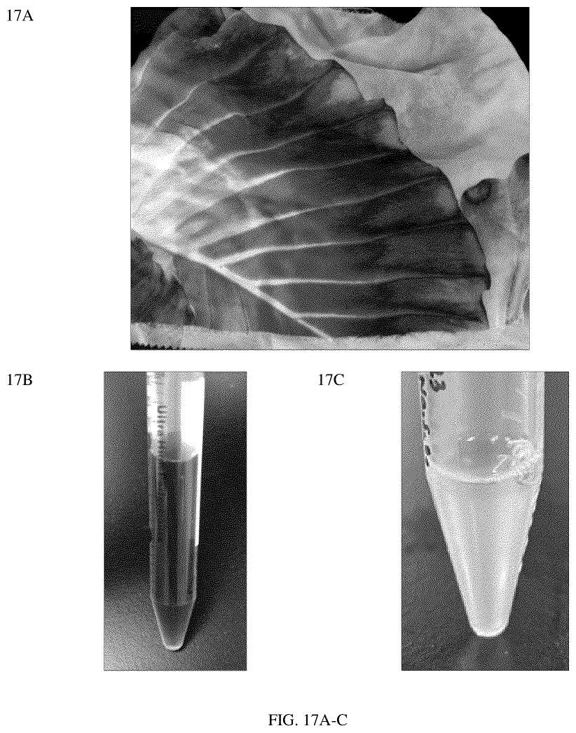

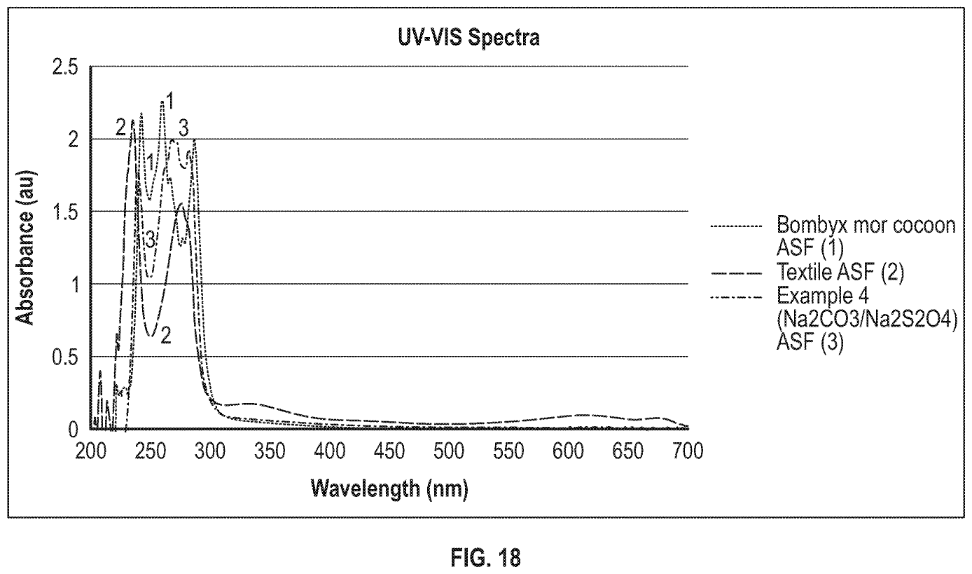

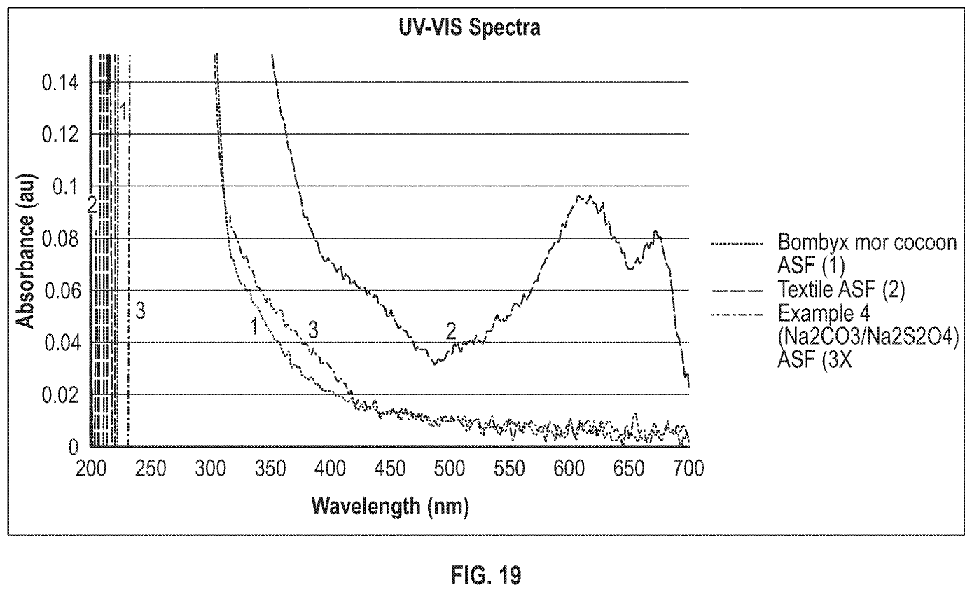

Graphs showing the resulting UV-Vis spectra for the blue textile are shown in FIG. 15 and FIG. 16, where FIG. 16 is a magnification of the spectrum in FIG. 15. The UV-Vis spectra for the patterned textile are shown in FIG. 18 and FIG. 19, where FIG. 19 is a magnified graph of the spectrum in FIG. 18.

### Example 7—Comparative Analysis of Dye Removal Variables

A series of experiments were run to determine ranges of procedural variables that influence dye removal efficiency. Chemical combination, chemical type, chemical concentration, processing time and processing temperature were evaluated.

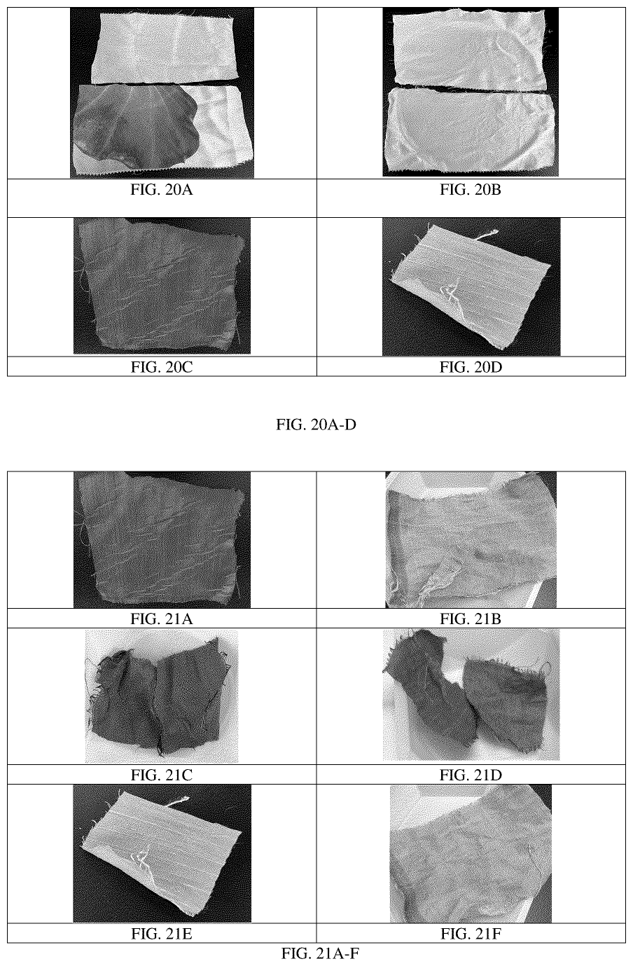

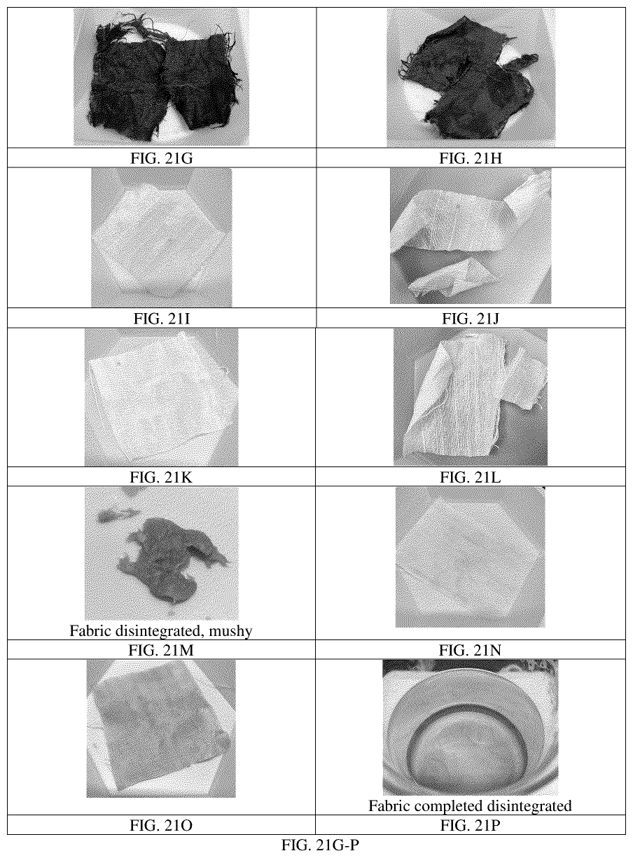

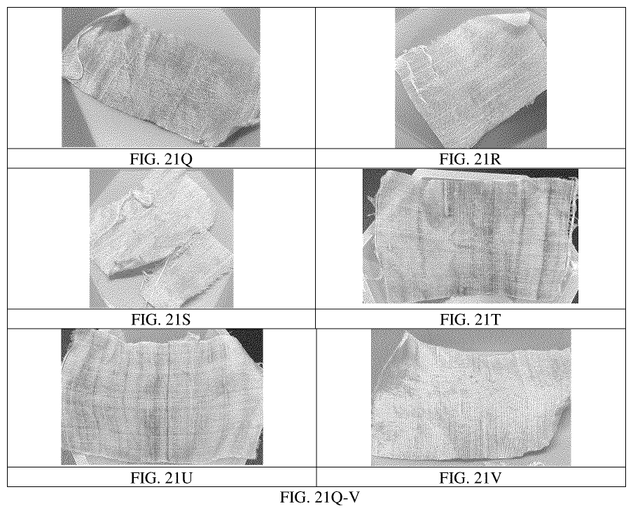

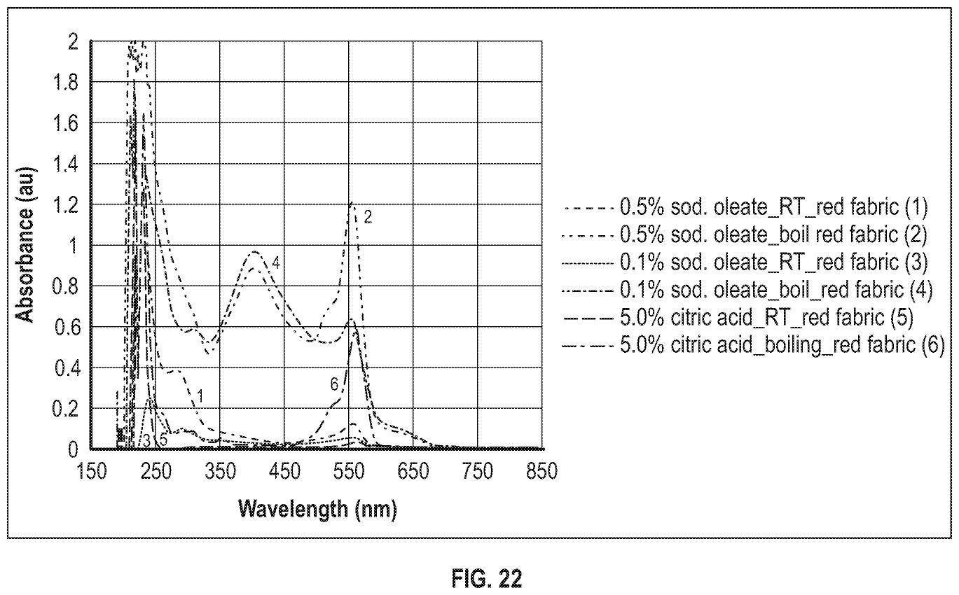

These experiments were performed using red silk textiles as comparison of the same removal process on two different silk textiles demonstrated that dye was more difficult to remove from a red silk textile than a blue or multicolored silk textile. This is shown in FIG. 20 A-D, which depicts multi-colored silk textiles before (FIG. 20A) and after (FIG. 20B) dye removal, as well as a red silk textile before (FIG. 20C) and after (FIG. 20D) dye removal.

### Temperature

To analyze temperature, sodium oleate was added to a beaker with water and stirred to make a 0.5% wt/v % sodium oleate solution. Once the sodium oleate dissolved, the fabric was added into the solution and treated for 30 minutes and incubated at either room temperature or 100° C. After treatment, the fabric was taken out of the solution and rinsed in water to wash off residual chemicals. The resulting fabric after 30 min at room temperature showed minimal color change (FIG. 21C) while some color change was present at 100° C. (FIG. 21B). This demonstrated that dye removal was possible at room temperature but was less effective compared to higher temperatures.

### Chemical Concentration

The chemical concentration of sodium oleate was analyzed by reducing the concentration by 80% (from 0.5 w/v % to 0.1 w/v %) or increasing the concentration to 1.0 wt/v % at both room temperature and while boiling.

The solutions of sodium oleate solution were made by adding sodium oleate to water and stirring until fully dissolved. The silk fabric was added into the solution and treated for 30-60 minutes at room temperature or the solution was boiled prior to the fabric being added. After treatment, the fabric was taken out of the solution and rinsed in water to wash off residual chemicals.

The results shown in FIG. 21B-F demonstrate that some dye removal is possible with a lower concentration of sodium oleate, but it was less effective compared to fabric treatment at a higher concentration. Lower concentrations of the sodium oleate were made more effective when treatment occurred at a higher temperature, leading to greater dye removal.

### Acid as Dye Remover

Citric acid was tested as a potential dye removal chemical. Citric acid was added to water to form a 5.0 wt/v % solution and stirred until it was fully dissolved. Then, the fabric was added into the solution and treated for 30 minutes at either room temperature or 100° C. as described above. After treatment, the fabric was taken out of the solution and rinsed in water to wash off residual chemicals.

As shown in FIG. 21G (room temperature) and 21H (100° C.), some dye removal was obtained, but citric acid was less effective compared to other chemicals (such as sodium oleate). By increasing the chemical concentration and the treatment temperature, more dye was removed.

### Combination of Dye Removal Solutions

An experiment was performed to test various combinations of dye removal solutions (RIT, laboratory made RIT, sodium oleate, Na₂CO₃, tetrasodium EDTA, dihydrate, sodium metasilicate, trisodium EDTA, trihydrate, Na₂S₂O₄) at different concentrations, temperatures, incubation times, and as one or two step processes, as shown below in Table 3. Results ranged from minimal to complete dye removal, with certain combinations additionally causing degradation or dissolution of the fabric, and thereby indicating a potential use as a one-step dissolution and dye removal process.

TABLE 3

| | | After | Dye Removal |
|---|---|---|---|
| Treatment 1 | Treatment 2 | Treatment | Outcome |
| None | None | FIG. 21A | N/A |
| 0.1 wt/v % sodium oleate | None | FIG. 21D | Minimal |
| (30 min, 100 C.) | | | |
| 0.5 wt/v % sodium oleate | None | FIG. 21C | Minimal |
| (30 min, room temp.) | | | |
| 0.5 wt/v % sodium oleate | None | FIG. 21B | Moderate |
| (30 min, 100 C.) | | | |
| 0.5 wt/v % sodium oleate | None | FIG. 21E | Moderate |
| (60 min, 120 C.) | | | |
| 1.0 wt/v % sodium oleate | None | FIG. 21F | Moderate |
| (30 min, 100 C.) | | | |
| 5.0 wt/v % citric acid | None | FIG. 21G | Minimal |
| (30 min, room temperature) | | | |
| 5.0 wt/v % citric acid | None | FIG. 21H | Minimal |
| (30 min, 100 C.) | | | |
| None | 1 wt/v % RIT | FIG. 21I | Moderate |
| | (60 min, 120 C.) | | |
| None | 0.5 wt/v % sodium | FIG. 21J | High |
| | oleate + | | |
| | 1 wt/v % RIT | | |
| | (60 min, 120 C.) | | |
| 0.5 wt/v % sodium oleate | 1 wt/v % RIT | FIG. 21K | Near |
| (60 min, 120 C.) | (60 min, 120 C.) | | complete |
| 0.5 wt/v % sodium oleate | 1 wt/v % RIT (made) | FIG. 21L | Complete |
| (60 min, 120 C.) | Na₂S₂O₄ | | |
| | Na₂CO₃ | | |
| | Tetrasodium EDTA | | |
| | Sodium metasilicate | | |
| | (60 min, 120 C.) | | |
| 0.5 wt/v % sodium oleate | 1 wt/v % Na₂CO₃ | FIG. 21M | N/A |
| (60 min, 120 C.) | (60 min, 120 C.) | | (damage to |
| | | | fabric) |
| 0.5 wt/v % sodium oleate | 1 wt/v % Na₂S₂O₄ | FIG. 21N | Moderate |
| (60 min, 120 C.) | (60 min, 120 C.) | | |
| 0.5 wt/v % sodium oleate | 1 wt/v % tetrasodium | FIG. 21O | Moderate |
| (60 min, 120 C.) | EDTA, dihydrate | | |
| | (60 min, 120 C.) | | |
| 0.5 wt/v % sodium oleate | 1 wt/v % sodium | FIG. 21P | N/A |
| (60 min, 120 C.) | metasilicate | | (damage to |
| | (60 min, 120 C.) | | fabric) |
| 0.5 wt/v % sodium oleate | 1 wt/v % trisodium | FIG. 21Q | Moderate |
| (60 min, 120 C.) | EDTA, trihydrate | | |
| | (60 min, 120 C.) | | |
| 0.5 wt/v % sodium oleate | 0.5 wt/v % | FIG. 21R | Complete |
| (60 min, 120 C.) | Na₂CO₃ + | | |
| | 0.5 wt/v % Na₂S₂O₄ | | |
| | (60 min, 120 C.) | | |
| 0.5 w/v % sodium oleate | 0.5 w/v % | FIG. 21S | Near |
| (30 min, 100 C.) | Na₂CO₃ + | | complete |
| | 0.5 w/v % Na₂S₂O₄ | | |
| | (30 min, 100 C.) | | |
| 0.5 w/v % sodium oleate | 0.25 w/v % | FIG. 21T | Moderate |
| (30 min, 100 C.) | Na₂CO₃ + | | |
| | 0.75 w/v % Na₂S₂O₄ | | |
| | (30 min, 100 C.) | | |
| 0.5 w/v % sodium oleate | 0.12 w/v % | FIG. 21U | Moderate |
| (30 min, 100 C.) | Na₂CO₃ + | | |
| | 0.88 w/v % Na₂S₂O₄ | | |
| | (30 min, 100 C.) | | |
| 1.0 w/v % sodium oleate | 0.25 w/v % | FIG. 21V | High |
| (30 min, 100 C.) | Na₂CO₃ + | | |
| | 0.75 w/v % Na₂S₂O₄ | | |
| | (30 min, 100 C.) | | |

Following completion of the experiments described above, once the textile was removed from the dye removal solution, each of the dye removal solutions was analyzed with the NanoDrop 2000 Spectrophotometer to determine the amount of color present in the solution (and therefore removed from the fabric). A collection of results is shown in Table 4, with the graph showing the UV-VIS spectra for these results provided in FIG. 22. The resulting dye removal solutions were compared to deionized water as a control.

TABLE 3

| | Absorbance of solution |
|---|---|
| | after treatment |
| | (500-600 nm) |
| 0.5 w/v % sodium oleate_RT | 0.126 |
| 0.5 w/v % sodium oleate_Boiling | 1.206 |
| 0.1 w/v % sodium oleate_RT | 0.056 |
| 0.1 w/v % sodium oleate_Boiling | 0.723 |
| 5.0 w/v % citric acid_RT | 0.036 |
| 0.5 w/v % citric acid_Boiling | 0.584 |
| DI water | 0.009 |

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that when used, the term “and/or”, includes any and all combinations of one or more of the associated listed items, if so provided. Further, “fabric” and “textile” are used herein interchangeably. A “silk textile” or “silk fabric” specifically includes textiles and fabrics that include other materials besides silk, including but not limited to cotton, linen, wool, cellulose fibers, or man-made materials. Unless otherwise defined, % concentration refers to % by weight/volume.

The term “about,” as used herein means, for example, within 10%, within 5%, or less. In some embodiments, the term “about” may mean within measurement error.

The terms first, second, third, etc. may be used herein to describe various reagents, elements, or steps. It should be understood that these reagents, elements, and/or steps should not be limited by these terms. These terms have been used only to distinguish one reagent, element, or step from another reagent, element or step. Thus, a first reagent, element, component, or step discussed herein could be termed a second reagent, element, or step without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A process for preparing aqueous silk fibroin from a textile comprising silk, comprising the steps of:
optionally boiling the textile;
dissolving the textile; and
performing dialysis or diafiltration on a solution resulting from dissolving the textile.

2. The process of claim 1, wherein optionally boiling the textile occurs in the presence of a degumming solution.

3. The process of claim 2, wherein the degumming solution is selected from the group consisting of: sodium carbonate (Na₂CO₃) solution, sodium dodecyl sulfate (SDS), an enzyme solution, papain, a surfactant, sodium oleate, soap, olive oil soap, Marseille soap, alkaline solution, sodium hydroxide, calcium hydroxide, sodium bicarbonate, acidic solutions, citric acid and tartaric acid.

4. The process of claim 3, wherein the degumming solution is Na₂CO₃.

5. The process of claim 4, wherein the Na₂CO₃ is present in an amount from about 0.01M to about 1M.

6. The process of claim 1, wherein dissolving the textile occurs in the presence of a dissolving solution, wherein the dissolving solution is a solution selected from the group consisting of: aqueous salt solutions, lithium bromide (LiBr), lithium thiocyanate, calcium nitrate solution, calcium chloride-formic acid, lithium/sodium thiocyanate, solutions of nitrate containing compounds, Hexafluoroisopropanol (HFIP), cupriethylenediamine (CED), phosphoric acid, lithium chloride (LiCl), ionic liquids, 1-allyl-3-methylimidazolium chloride ([AMIM]Cl), ajisawa reagents and CaCl₂:ethanol:water.

7. The process of claim 6, wherein dissolving solution is an aqueous solution of LiBr.

8. The process of claim 7, wherein the LiBr is present in an amount from about 9M to about 10M.

9. The process of claim 1, wherein the process additionally comprises the step of removing dye from the textile.

10. The process of claim 9, wherein removing dye from the textile comprises incubating the textile in a dye removal solution, wherein the dye removal solution is a solution comprising one or more color removers selected from the group consisting of: non-reductive (oxidative) bleaches, chlorine-based bleach, sodium hypochlorite (NaOCl), calcium hypochlorite, oxygen-based bleach, hydrogen peroxide, sodium percarbonate, sodium perborate, ozone, Peracetic Acid, Potassium Persulfate, Reductive bleaches, Bisulfites/Sulfites, sulfur dioxide, sodium bisulfite, sodium metabisulfite, sodium dithionite, thiourea dioxide, formamidine sulfinic acid, RIT color remover, sodium hydrosulfite, sodium carbonate, water, acids, vinegar, oxalic acid, hydrochloric acid, formic acid, surfactants, emulsifiers, sodium oleate, soap, Marseille soap, and sodium dodecyl sulfate (SDS).

11. The process of claim 10, wherein the dye removal solution is a solution of NaOCl. or Na₂CO₃/Na₂S₂O₄.

12. The process of claim 11, wherein the NaOCl additionally dissolves the textile.

13. The process of claim 11, wherein the NaOCl is present in an amount from about 1% to about 4%.

14. The process of claim 9, wherein the step of removing dye from the textile comprises incubating the textile in a solution comprising sodium hydrosulfite and sodium carbonate prior to dissolving the textile.

15. The process of claim 10, wherein the step of removing dye from the textile additionally comprises the steps of:
incubating the textile in a heated and pressurized vessel in the presence of a surfactant; and
incubating the textile in a heated and pressurized vessel in the presence of a dye removal solution.

16. A process for preparing aqueous silk fibroin from a textile comprising silk, comprising the steps of:
adding the textile to a dissolving solution, wherein the solution dissolves the textile;
performing dialysis or diafiltration on the dissolved textile solution; and,
optionally centrifuging the dialyzed or diafiltration solution.

17. A process for preparing aqueous silk fibroin from a textile comprising silk, comprising the steps of:
pre-washing the textile in warm water;
adding a dye removal agent to hot water;
pre-washing the textile in warm water;
adding the textile into the dye removal solution;
removing the textile;
rinsing the textile in water;
dissolving the textile;
performing dialysis or diafiltration on the dissolved textile solution; and,
optionally centrifuging the dialyzed or diafiltration solution.

18. A process for preparing aqueous silk fibroin from a textile comprising silk, comprising the steps of:
pressure-cooking or boiling the textile in a surfactant;
pressure-cooking or boiling the textile in a dye removal solution;
dissolving the textile;
performing dialysis or diafiltration on the dissolved textile solution; and,
optionally centrifuging the dialyzed or diafiltration solution.

19. The process of claim 18, wherein the degumming solution comprises LiBr and the dye removal solution comprises Na₂CO₃/Na₂S₂O₄.

20. An aqueous silk fibroin prepared by dissolving a textile comprising silk.

21. The aqueous silk fibroin of claim 20, the dissolving comprises the steps of:
providing a silk textile;
optionally boiling the textile;
dissolving the textile; and
performing dialysis or diafiltration on a solution resulting from dissolving the textile; wherein the dialyzed solution comprises aqueous silk fibroin.

22. The aqueous silk fibroin of claim 21, wherein the textile is treated to remove dye prior to concurrent with dissolving the textile.
